(19) United States
(12) Patent Application Publication
(10) Pub. No.: US 2026/0304503 A1
(43) Pub. Date: Oct. 1, 2026

(54) METHODS, SYSTEMS, AND COMPUTER READABLE MEDIA FOR RE-USING MONITORING KEY IN QUOTA MANAGEMENT BY POLICY CONTROL FUNCTION (PCF)

(71) Applicant: Oracle International Corporation, Redwood Shores, CA (US)

(72) Inventors: Abhishek Mukherjee, Bangalore (IN); Vivek Pant, Bangalore (IN); Hamza Salim, Ujjain (IN)

(21) Appl. No.: 19/094,823

(22) Filed: Mar. 29, 2025

(51) Int. Cl. H04W 76/10; H04W 8/18; H04W 24/08

(52) U.S. Cl. CPC H04W 76/10; H04W 8/18; H04W 24/08

(57) ABSTRACT

A method for re-using a monitoring key in quota management by a policy control function (PCF) includes receiving, from a session management function (SMF), a first session establishment request message for establishing a first packet data unit (PDU) session involving a subscriber. The method further includes fetching, by the PCF and from a unified data repository (UDR), a subscriber profile having a first usage monitoring profile including a first limitId. The method further includes creating a mapping between a monitoring key and the first limitId. The method further includes communicating, to the SMF, the monitoring key. The method further includes re-using the monitoring key for a second PDU session, the second PDU session having a second usage monitoring profile different from the first usage monitoring profile, the second usage monitoring profile including a second limitId different from the first limitId.

### TECHNICAL FIELD

The subject matter described herein relates to monitoring subscriber quota usage in communication networks. More particularly, the subject matter described herein relates to methods, systems, and computer readable media for re-using a monitoring key by a PCF in performing quota management.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that may occur in current network architectures is that a monitoring key used to track subscriber data usage is tied to a limitId, used to identify a subscriber data plan, and the monitoring key cannot be re-used with other data plans or limitIds. Network operators may provision policy rules for subscriber data plans on the session management function (SMF). Many of the different data plans offered by the network operator may use some of the same policy rules, such as charging rates, data limits, etc. For example, there may only be 20 unique policy and charging control (PCC) rules but the network operator may implement hundreds of data plans using different combinations of the policy and charging control rules. Because the monitoring key is uniquely associated with a limitId used to identify a data plan, the network operator is required to statically provision on the SMF a PCC rule set for each of the data plans, even though some of the rules may be duplicative of the rules used in other data plans. Provisioning unique rule sets for each data plan at the SMF is wasteful of SMF resources.

Accordingly, in light of these and other difficulties, there exists a need for improved methods, systems, and computer readable media for efficiently storing PCC rules at the SMF and using the rules to make policy decisions for subscriber network usage.

### SUMMARY

A method for re-using a monitoring key in quota management by a PCF includes receiving, by the PCF and from an SMF, a first session establishment request message for establishing a first packet data unit (PDU) session involving a subscriber. The method further includes fetching, by the PCF and from a unified data repository (UDR), a subscriber profile having a first usage monitoring profile and including a first limitId. The method further includes creating, by the PCF, a mapping between a monitoring key and the first limitId. The method further includes communicating, by the PCF and to the SMF, the monitoring key. The method further include re-using, by the PCF, the monitoring key for a second PDU session, the second PDU session having a second usage monitoring profile different from the first usage monitoring profile, the second usage monitoring profile including a second limitId different from the first limitId.

According to another aspect of the subject matter described herein, receiving the first session establishment request message includes receiving the first session establishment request message from the SMF.

According to another aspect of the subject matter described herein, fetching the subscriber profile from the UDR includes transmitting, by the PCF and to the UDR, a user profile request message including a subscriber Id obtained from the session establishment request message.

According to another aspect of the subject matter described herein, the method for re-using a monitoring key in quota management by a PCF includes reading, by the PCF and from the first usage monitoring profile, the first limitId and wherein creating the mapping between the monitoring key and the first limitId includes creating a record in a policy database local to the PCF and storing the first limitId and the monitoring key in the record.

According to another aspect of the subject matter described herein, the method for re-using a monitoring key in quota management by a PCF includes receiving from the SMF, an N7 session terminate request message including the monitoring key, and, in response, terminating the first PDU session.

According to another aspect of the subject matter described herein, the method for re-using a monitoring key in quota management by a PCF includes re-using the monitoring key for the second PDU session includes fetching, by the PCF and from the UDR, a subscriber profile having the second usage monitoring profile and the second limitId, creating, by the PCF, a mapping between the monitoring key and the second limitId.

According to another aspect of the subject matter described herein, re-using the monitoring key for the second PDU session includes communicating the monitoring key to the SMF in a usage monitoring grant for the second PDU session.

According to another aspect of the subject matter described herein, the method for re-using a monitoring key for quota management by a PCF includes reading, by the PCF and from the second usage monitoring profile, the second limitId and wherein creating the mapping between the monitoring key and the second limitId includes creating a record in a policy database local to the PCF and storing the second limitId and the monitoring key in the record.

According to another aspect of the subject matter described herein, the monitoring key comprises a usage monitoring Id (umId).

According to another aspect of the subject matter described herein, the method for re-using a monitoring key for quota management by a PCF includes storing, at the SMF, a single policy and charging control (PCC) rule for the first and second usage monitoring profiles.

According to another aspect of the subject matter described herein, a system for re-using a monitoring key in quota management by a PCF is provided. The system includes a PCF including at least one processor and a memory. The system further includes a policy database stored in the memory. The system further includes a policy manager implemented by the at least one processor for receiving, an SMF, a first session establishment request message for establishing a first PDU session involving a subscriber, fetching, from a UDR, a subscriber profile including a first usage monitoring profile identified by a first limitId, creating, by the PCF, a mapping between a monitoring key and the first limitId, communicating, to the SMF, the monitoring key, and re-using the monitoring key for a second PDU session, the second PDU session having a second usage monitoring profile different from the first usage monitoring profile, the second usage monitoring profile including a second limitId different from the first limitId.

According to another aspect of the subject matter described herein, the policy manager is configured to receive the first session establishment request message from the SMF.

According to another aspect of the subject matter described herein, the policy manager is configured to fetch the subscriber profile from the UDR by transmitting a user profile request message including a subscriber Id obtained from the session establishment request message.

According to another aspect of the subject matter described herein, the policy manager is configured to read, from the first usage monitoring profile, the first limitId and to create the mapping between the monitoring key and the first limitId by creating a record in the policy database and storing the first limitId and the monitoring key in the record.

According to another aspect of the subject matter described herein, the policy manager is configured to receive from the SMF, an N7 session terminate request message including the monitoring key, and, in response, terminate the first PDU session.

According to another aspect of the subject matter described herein, the policy manager is configured to re-use the monitoring key for the second PDU session by: fetching, from the UDR, a subscriber profile including the second usage monitoring profile including the second limitId; and creating a mapping between the monitoring key and the second limitId.

According to another aspect of the subject matter described herein, the policy manager is configured to re-use the monitoring key for the second PDU session by communicating the monitoring key to the SMF in a usage monitoring grant for the second PDU session.

According to another aspect of the subject matter described herein, the policy manager is configured to read from the second usage monitoring profile, the second limitId and create the mapping between the monitoring key and the second limitId by creating a record in the policy database and storing the second limitId and the monitoring key in the record.

According to another aspect of the subject matter described herein, a non-transitory computer readable medium having stored thereon executable instructions that when executed by a processor of a computer control the computer to perform steps is provided. The steps include receiving, by a PCF and from an SMF, a first session establishment request message for establishing a first PDU session involving a subscriber. The steps further include fetching, by the PCF and from a UDR, a subscriber profile having a first usage monitoring profile including a first limitId. The steps further include creating, by the PCF, a mapping between a monitoring key and the first limitId. The steps further include communicating, by the PCF and to the SMF, the monitoring key. The steps further include re-using, by the PCF, the monitoring key for a second PDU session, the second PDU session having a second usage monitoring profile different from the first usage monitoring profile, the second usage monitoring profile having a second limitId different from the first limitId.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 illustrates network entities involved in policy and charging control in a communication network;

FIG. 3 is a message flow diagram illustrating exemplary messages exchanged in applying a data plan to a PDU session;

FIG. 4 illustrates the problem of storing separate preconfigured PCC/session rules at the SMF even though all of the parameters of the PCC/session rules except for the monitoring key are the same;

FIG. 5 illustrates the re-use of a monitoring key for different PCC/session rules corresponding to different data plans;

FIG. 6 is a message flow diagram illustrating the re-use of monitoring keys for different data plans;

FIG. 7 is a block diagram illustrating an exemplary architecture of a PCF for implementing the subject matter described herein; and

FIG. 8 is a flow chart illustrating an exemplary process for re-using a monitoring key in quota management by a PCF.

### DETAILED DESCRIPTION

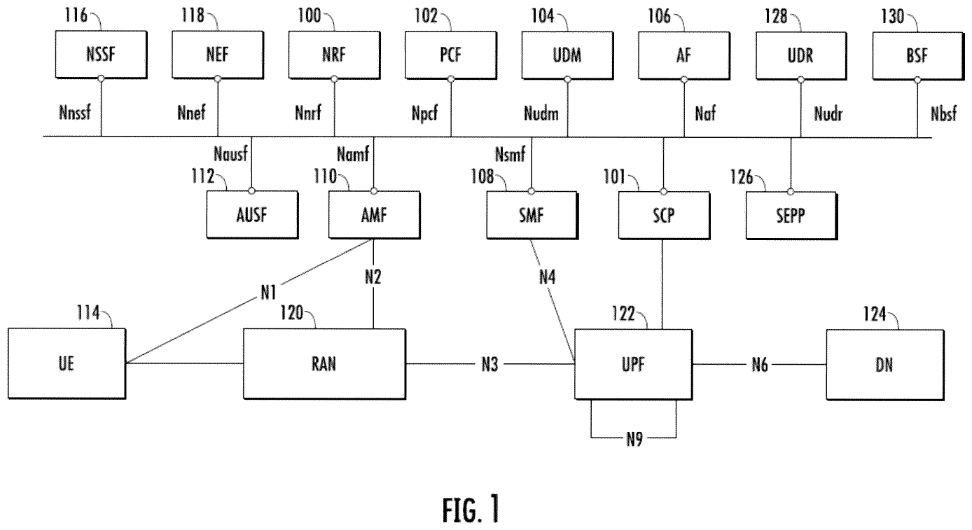

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a PCF 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with an SEPP in a foreign PLMN which manages security for the foreign PLMN. Thus, traffic between NFs in different PLMNs may traverse two SEPP functions, one for the home PLMN and the other for the foreign PLMN. A UDR 128 stores subscription data for UEs. A binding support function (BSF) 130 manages bindings between PDU sessions and PCFs.

As stated above, one problem in current network architectures is that the monitoring key used to track subscriber data usage is uniquely tied to the limitId used to identify a data plan and cannot be re-used with other data plans or limitIds, resulting in inefficient resource utilization the SMF. The subject matter described herein addresses this difficulty by allowing a monitoring key to be re-used by maintaining and updating mappings between a monitoring key and limitIds at the PCF. The mapping between the monitoring key and a limitId can be updated when the data plan being applied to subscriber data usage changes.

The 3GPP standards for policy and charging control in 5G core networks require that PCC network functions (such as the PCF and the SMF) perform gating control, charging control, and QoS control for packet data flows and to base such decisions upon subscription information, access type, radio access type (RAT), etc. Such control of the data flow packets is implemented by the SMF based on rules provided by PCF. The PCC network functions control the flow of data packets at a service level or at a PDU session level. The PCF provides a policy decision to the SMF containing rules, known as PCC rules, for the service level and as session rules for the session level.

A PCC rule may be pre-defined and stored in memory of the SMF or dynamically provisioned when a PDU session is established. The subject matter described herein provides for more efficient provisioning of predefined rules at the SMF by breaking the fixed association between a single limitId and a monitoring key.

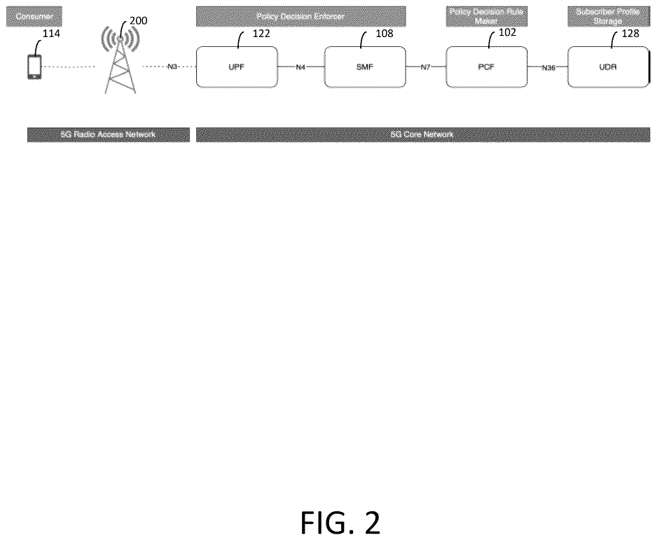

FIG. 2 illustrates network entities involved in policy and charging control in a communication network. In FIG. 2, the entities include PCF 102, which makes policy decisions using subscriber data obtained from UDR 128. SMF 108 requests and obtains policy information from PCF 102 and enforces policy rules, either statically provisioned in SMF 108 or received from PCF 102. UPF 122 communicates with a base station 200 to connect UE 114 to the core network.

### Usage Monitoring Overview

PCF 102 is responsible for monitoring the overall amount of resources that are consumed by a user and to control usage independently from charging mechanisms. This procedure is called usage monitoring control. SMF 108 may monitor both volume and time of usage and report the accumulated usage of network resources to PCF 102 for PDU sessions of type IP and Ethernet. It is possible to apply usage monitoring for the accumulated usage of network resources on a per session and user basis. This capability is required for enforcing dynamic policy decisions based on the total network usage in real-time. PCF 102 uses usage monitoring for making dynamic policy decisions and sets and sends the applicable thresholds to SMF 108 for monitoring. The usage monitoring thresholds may be based on time, volume, or both. PCF 102 may send time and volume thresholds to SMF 108. SMF 108 notifies PCF 102 when a threshold is reached and reports the accumulated usage since the last report for usage monitoring. If both time and volume thresholds were provided to SMF 108, the accumulated usage since last report may be reported to PCF 102 when either the time or the volume thresholds are reached. It should be noted that it is possible to activate usage monitoring for service data flows associated with predefined PCC rules and dynamic PCC rules.

### Usage Monitoring Terminology

The following terminology is used in explaining the present subject matter:

Usage monitoring profile/data plan/quota plan: These terms define the thresholds and other properties of a policy or plan that is implicitly allotted to or explicitly purchased by a subscriber.

### Examples

1. A monthly data plan that allows the subscriber to consume 10G of data every month. That is, this data plan has a threshold of 10G for a single period of consumption, and the period is reset every 30 days.
2. A one-time data plan to allow the subscriber to consume 100G of data in a 6 month duration. The 6 month duration may be counted from date of purchase or date of activation, i.e., on first use of the plan.
3. A roaming data plan that allows the subscriber to consume 30G of data while in a specific country or region.
4. A service plan that allows the subscriber to stream 20G of audio/video from specific platforms.

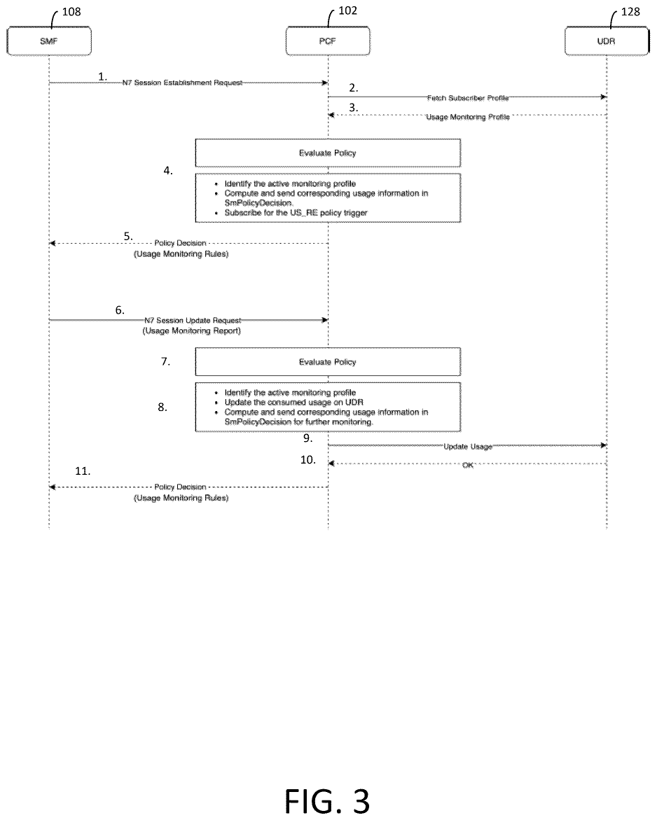

FIG. 3 is a message flow diagram illustrating exemplary messages exchanged in applying a data plan to a PDU session. Referring to FIG. 3, in step 1, SMF 108 sends an N7 session establishment request to PCF 102. In step 2, PCF 102 requests a subscriber profile from UDR 128. In step 3, UDR 128 provides the subscriber profile, including the usage monitoring profile for the subscriber. In step 4, PCF 102 evaluates the policy to be applied to the PDU session, identifies the active monitoring profile to be applied to the PDU session, computes and sends the corresponding usage information in an SM policy decision and subscribes with SMF 108 for the US_RE policy trigger. In step 5, PCF 102 communicates the policy decision, including the usage monitoring rules, to SMF 108. SMF 108 stores the policy rules and begins applying the policy rules to the PDU session. In step 6, SMF 108 sends an N7 session update request including a usage monitoring report to PCF 102. In step 8, PCF 102 evaluates the policy including identifying the active monitoring profile, updating consumed usage on UDR 128, and computing and sending the corresponding usage information in an SmPolicyDecision for further monitoring. In step 9, PCF 102 communicates the updated usage information to UDR 128. In step 10, UDR 128 responds with an OK message. In step 11, PCF 102 sends a policy decision including the usage monitoring rules to SMF 108.

### Problem Addressed

5th Generation releases of the 3GPP specifications define the structure and model of usage monitoring data to be stored on the UDR. This data is primarily categorized into 2 types:
1. Data plan as described in the section above with specific thresholds and other properties. This is provisioning data.
2. Accumulation data that keeps track of the usage or consumption. This is runtime data.
   This data is fetched by PCF 102 and translated into a usage monitoring decision or rules and sent to SMF 108. The relationship between the usage monitoring data profiles stored on UDR 128 and the usage monitoring decision sent to SMF 108 is also defined by the 3GPP Technical Specifications. Table 5.4.2.6-1 of the 3GPP Technical Specification 29.519 defines the model of a UsageMonDataLimit instance, which is also known as a usage monitoring control instance. This model represents a single a data plan as described above. The data plan is identified by an attribute referred to as the limitId. Each data plan provisioned for a subscriber needs to be uniquely identified by a limitId. As mentioned in the examples in the previous section, a given subscriber may be entitled to multiple data plans, applicable based on geographic location, time of day, service usage, etc. Note 1 of Table 5.4.2.6-1 of 3GPP TS 29.519 mentions that the limitId attribute is the monitoring key, which is defined in 3GPP TS 29.512. However, as described herein, the monitoring key is a separate parameter from the limitId and can be mapped to different limitIds.

PCF 102 fetches the provisioned data plans for a given subscriber and applies operator configured policy to derive the usage monitoring decision to be sent to SMF 108. PCF 102 sends the policy decision to SMF 108 in the form of session and/or PCC rules. The usage monitoring decision is associated with each of the session and/or PCC rules.

Tables 5.6.2.6-1 and 5.6.2.7-1 of the 3GPP Technical Specification 29.512 define the model of a PCC rule and a session rule, respectively. Each PCC rule or session rule's usage monitoring decision instance is identified by a usage monitoring ID (umId), which is the same as the monitoring key, as indicated in section 4.1.4.4.5 of TS 29.512 (Release 17).

In short, data plans configured in UDR 128 are identified by unique limitIds, and the same limitIds are supposed to be used as umIds when sending the usage monitoring decision in PCC/session rules to SMF 108.

### Problem

Network operators create data plans based on different business cases. For example,
1. Plans based on location like domestic or roaming plans, such as continental and worldwide plans,
2. Plans based on time of day, such as daytime and nighttime plans,
3. Plans based on day of week, such as weekend-specific plans,
4. Plans based on occasions, such as festival day plans,
. . . and many others, depending on business cases offered by the operator. Thus, any given operator may offer a large number of data plans, each plan being uniquely identified by a limitId.

When an operator chooses to use pre-defined PCC/session rules at the SMF, i.e., PCC/session rules that are pre-configured at the SMF, a large number of such rules need to be provisioned at the SMF because of the one-to-one relation of umId to limitId. Note that the umId of a pre-configured PCC/session rule is also statically configured in that rule. Hence, the SMF needs to be aware of all possible umIds (also known as monitoring keys) that the PCF can send. This leads to the large number of PCC/session rule combinations at the SMF.

Provisioning a static PCC/session rule for each data plan at the SMF is unnecessary as, apart from the monitoring key, other parameters, such as charging parameters, QoS parameters, and traffic control decision parameters, may be common or the same in different PCC/session rules across data plans. Also, the SMF may have an operational restriction on the number of PCC/session rules that can be pre-configured.

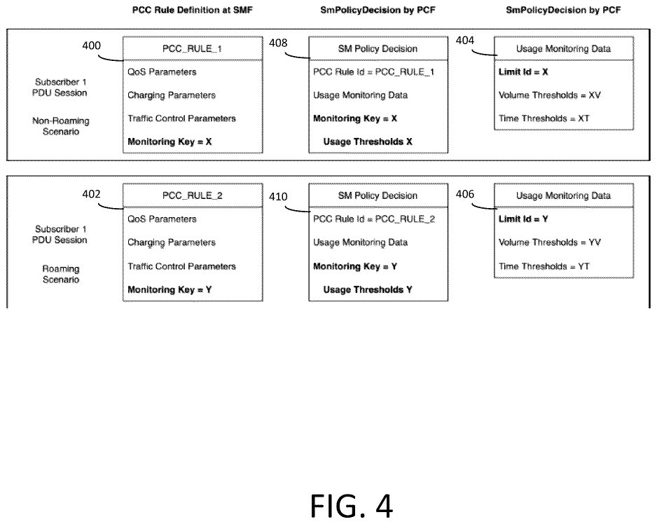

FIG. 4 illustrates the problem of storing separate preconfigured PCC/session rules at the SMF even though all of the parameters of the PCC/session rules except for the monitoring key are the same. In FIG. 4, PCC/session rules include a PCC/session rule 400 for a non-roaming scenario identified as PCC_Rule_1 and containing monitoring key X and a PCC/session rule 402 for a roaming scenario identified as PCC_Rule_2 and containing monitoring key Y. PCC/session rules 400 and 402 include the same parameters except for their respective monitoring keys. Monitoring key X is associated with limitId X of usage monitoring data 404 maintained by PCF 102, and monitoring key Y is associated with limitId Y of usage monitoring data 406 maintained by PCF 102. PCF 102 maintains SmPolicyDecision instances 408 and 410 that include the monitoring keys X and Y and the limitIds X and Y that are associated with the usage thresholds.

Because monitoring keys X and Y are uniquely associated with limitIds X and Y, monitoring keys X and Y cannot be re-used in different PCC/session rules. Because monitoring keys X and Y cannot be re-used in different PCC/session rules, a separate PCC/session rule must be provisioned in SMF 108 for each monitoring key, even if some or all of the other parameters of the PCC/session rules are the same.

### Solution Overview

The subject matter described herein includes a solution to the unique monitoring key problem described above by enabling PCF 102 to manage and de-couple the limitId to monitoring key relation. PCF 102 provides the capability to re-use monitoring keys across multiple different data plans. This will help the operator to provision a lower number of PCC/session rules at SMF 108. The same monitoring key may be associated with different PCC/session rules for different data plans, as decided by PCF 102.

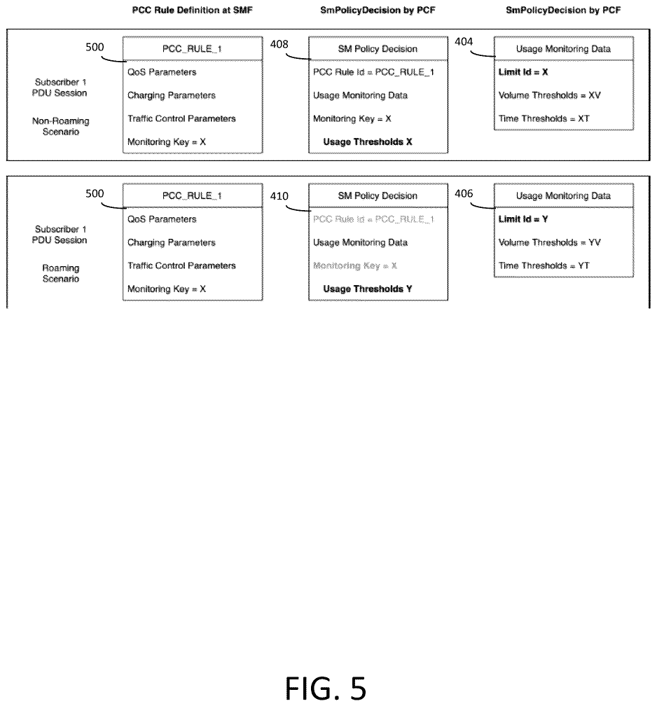

FIG. 5 illustrates the re-use of a monitoring key for different PCC/session rules corresponding to different data plans. In the scenario illustrated in FIG. 5, the network operator offers a non-roaming data plan and a roaming data plan. The non-roaming data plan is associated with limitId X. The roaming data plan is associated with limitId Y. PCF 102 maintains usage monitoring data 404 and 406 and SmPolicyDecision instances 408 and 410 for the two data plans. However, because monitoring key X can be re-used across data plans, SMF 108 only needs to be provisioned with a single PCC/session rule 500 for both data plans.

### Solution Details

PCF 102 stores various session related data in its policy database. For example, UE attributes, such as identifiers, location, etc., PCF 102 also stores policy decisions, such as previously granted PCC/session rules. PCF 102 additionally stores the granted data plan(s) and the corresponding monitoring key(s) as part of the session context. Storing monitoring keys and granted data plans associated with a session context enables PCF 102 to map the monitoring key received in a SM-Policy update/terminate request message to the corresponding data plan (limitId) that was granted earlier. Once the limitId is known to PCF 102, PCF 102 can use the limitId to update the accumulated usage with UDR 128. This mechanism enables PCF 102 to de-couple the monitoring key from the limitIds of different data plans and thereby enable PCF 102 to re-use a monitoring key for different data plans. Re-using the monitoring key helps the operator to reduce the number of PCC/session rules that need to be pre-configured on SMF 108.

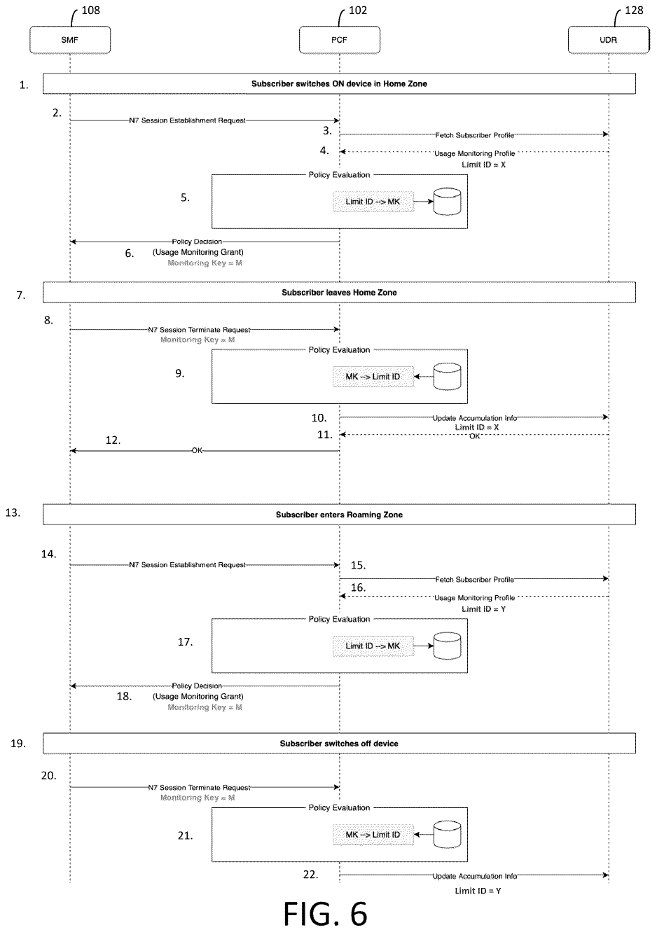

FIG. 6 is a message flow diagram illustrating the re-use of monitoring keys for different data plans. Referring to FIG. 6, in step 1, a subscriber activates his or her UE in a home network zone of the subscriber. In step 2, SMF 108 sends an N7 session establishment request to PCF 102. In step 3, PCF 102 sends a request to UDR 128 to fetch the subscriber's profile. In step 4, UDR 128 responds with the subscriber's profile, including policy limitId X for the profile. In step 5, PCF 102 performs a policy evaluation and associates the limitId X with a monitoring key M by creating the record in the policy database maintained by PCF 102 associating the limitId X with the monitoring key M. In step 6, PCF 102 communicates the policy decision including the monitoring key M to SMF 108.

In step 7, the subscriber leaves the home network zone. In step 8, SMF 108 sends an N7 session terminate request including the monitoring key M to PCF 102. In step 9, PCF 102 uses the monitoring key M to look up the record in the policy database corresponding to the monitoring key M. In step 10, PCF sends updated accumulated usage information for the limitId X to UDR 128. In step 11, UDR 128 responds with an OK message. In step 12, PCF 102 sends an OK message to SMF 108.

In step 13, the subscriber enters a roaming network zone. In step 14, SMF 108 sends an N7 session establishment request to PCF 102. In step 15, PCF 102 sends a request to UDR 128 to fetch the subscriber's profile. In step 16, UDR 128 responds with the subscriber's profile including policy limitId Y. In step 17, PCF 102 performs a policy evaluation and re-uses the monitoring key M by associating the limitId Y with the monitoring key M in a record in the policy database maintained by PCF 102. In step 18, PCF 102 communicates the policy decision including the monitoring key M to SMF 108.

In step 19, the subscriber switches off his or her communication device. In step 20, SMF 108 sends an N7 terminate request to PCF 102. In step 21, PCF 102 uses the monitoring key M to look up the record corresponding to the limitId Y in the policy database and performs a policy evaluation. In step 22, PCF 102 sends updated accumulated usage information for the limitId Y to UDR 128. Thus, by re-using a monitoring key for different policy rule instances, PCF 102 reduces the number of unique policy rules that need to be provisioned on SMF 108.

### Limitations

The following limitations are implementation details and are not intended to limit the scope of the subject matter described herein.
1. All usage monitoring grants provided in a single decision from PCF 102 to SMF 108 shall have unique monitoring keys. For example, if the usage-monitoring-decision in a SmPolicyDecision response contains more than one grant, e.g., two SERVICE_LEVEL grants for different PCC rules, then these grants must have unique monitoring keys.
2. If a usage monitoring control instance (i.e. the quota profile/plan) is changed by PCF as part of an in-session decision, for example an SM-Policy-Update response, then the new monitoring key used shall be different from the old monitoring key that was reported in the SM-Policy-Update request message unless the data plan represented by the old monitoring key has been fully consumed. Using the same monitoring key for an in-session policy decision prevents the SMF from realizing that the usage monitoring control instance has changed and thus may result in inaccurate usage reporting.

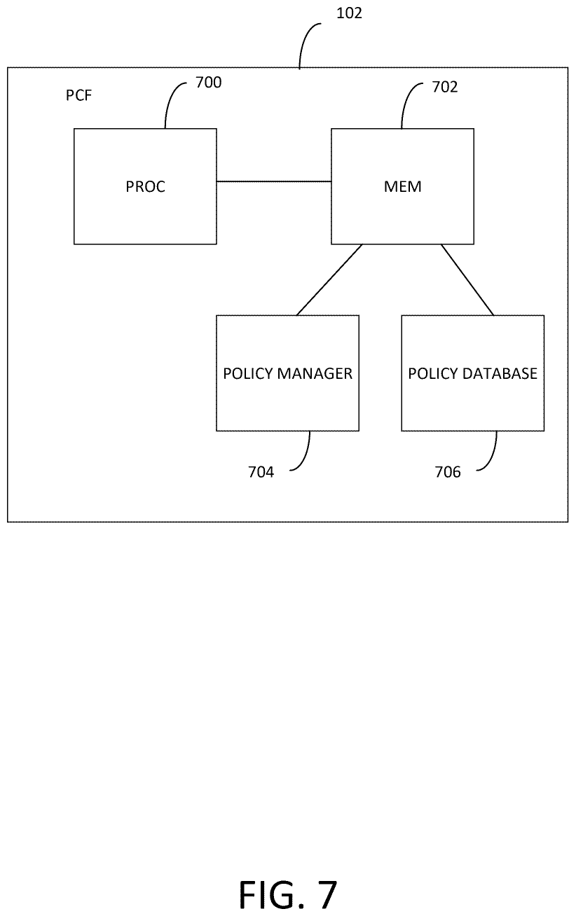

FIG. 7 is a block diagram illustrating an exemplary architecture of a PCF for implementing the subject matter described herein. Referring to FIG. 7, PCF 102 includes at least one processor 700 and memory 702. PCF 102 further includes a policy manager 704 and a policy database 706. Policy manager 704 performs the steps described herein for fetching subscriber profiles from UDR 128, communicating with SMF 108, and re-using monitoring keys for different limitIds. Policy database 706 stores policy rules and includes database records that create a mapping between a monitoring key and a limitId and which can be updated by policy manager 704 to re-use monitoring keys for different limitIds associated with different usage monitoring profiles. Policy manager 704 may be implemented using computer executable instructions stored in memory 702 and executed by processor 700.

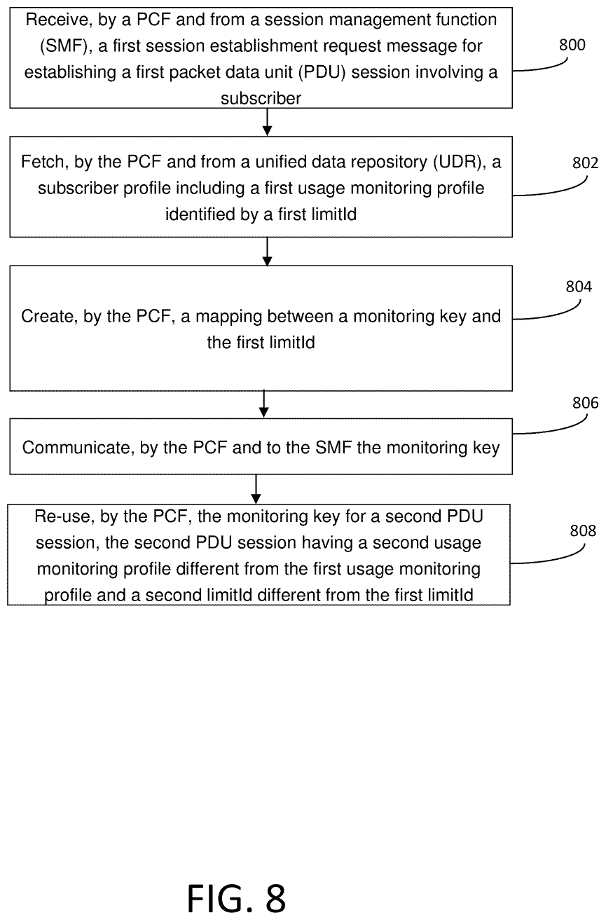

FIG. 8 is a flow chart illustrating an exemplary process for re-using a monitoring key in quota management by a PCF. Referring to FIG. 8, in step 800, the process includes receiving, by a PCF and from a session management function (SMF), a first session establishment request message for establishing a first packet data unit (PDU) session involving a subscriber. For example, a PCF, such as PCF 102, may receive an N7 session establishment request when a UE connects to the network and seeks to access data provided under a data plan.

In step 802, the process further includes fetching, by the PCF and from a unified data repository (UDR), a subscriber profile including a first usage monitoring profile identified by a first limitId. For example, a PCF, such as PCF 102, may transmit a message to UDR 128 requesting a subscriber profile, where the subscriber profile includes one or more usage monitoring profiles, each including a limitId.

In step 804, the process further includes creating, by the PCF, a mapping between a monitoring key and the first limitId. For example, a PCF, such as PCF 102, may assign a monitoring key to the PDU session and create a record in the policy database mapping the monitoring key to the first limitId.

In step 806, the process further includes communicating, by the PCF and to the SMF, the monitoring key. For example, a PCF, such as PCF 102, may communicate the monitoring key to the SMF in a usage monitoring grant for the first PDU session.

In step 808, the process further includes re-using, by the PCF, the monitoring key for a second PDU session, the second PDU session having a second usage monitoring profile different from the first usage monitoring profile and the second usage monitoring profile including a second limitId different from the first limitId. For example, a PCF, such as PCF 102, may receive, after termination of the first PDU session, an N7 session establishment request for a second PDU session. PCF 102 may fetch the subscriber profile for the second PDU session from UDR 128, determine that the subscriber profile includes a usage monitoring profile having a second limitId different from the first limitId and create a mapping between the second limitId and the monitoring key. PCF 102 may communicate the monitoring key to SMF 108 in a usage monitoring grant for the second PDU session.

Thus, by maintaining and updating mappings between monitoring keys and limitIds, a PCF as described herein enables the SMF to re-use a PCC rule for multiple different limitIds associated with different usage monitoring profiles. The re-use of monitoring keys by the PCF increases the efficiency of utilization of memory and processing resources of the SMF.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.1.0 (2024 December)
2. 3^{rd} Generation Partnership Project; Technical Specification Group Services and System Aspects; Policy and charging control framework for the 5G System (5GS); Stage 2 (Release 19) 3GPP TS 23.503 V19.2.0 (2024 December)
3. 3^{rd} Generation Partnership Project; Technical Specification Group Core Network and Terminals; 5G System; Session Management Policy Control Service; Stage 3 (Release 19) 3GPP TS 29.512 V19.2.0 (2025 March)
4. 3^{rd} Generation Partnership Project; Technical Specification Group Core Network and Terminals; 5G System; Usage of the Unified Data Repository service for Policy Data, Application Data, and Structured Data for Exposure; Stage 3 (Release 19) 3GPP TS 29.519 V19.1.0 (2024 December)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for re-using a monitoring key in quota management by a policy control function (PCF), the method comprising:
receiving, by a PCF and from a session management function (SMF), a first session establishment request message for establishing a first packet data unit (PDU) session involving a subscriber;
fetching, by the PCF and from a unified data repository (UDR), a subscriber profile having a first usage monitoring profile including a first limitId;
creating, by the PCF, a mapping between a monitoring key and the first limitId;
communicating, by the PCF and to the SMF, the monitoring key; and
re-using, by the PCF, the monitoring key for a second PDU session, the second PDU session having a second usage monitoring profile different from the first usage monitoring profile, the second usage monitoring profile including a second limitId different from the first limitId.

2. The method of claim 1 wherein receiving the first session establishment request message includes receiving the first session establishment request message from the SMF.

3. The method of claim 1 wherein fetching the subscriber profile from the UDR includes transmitting, by the PCF and to the UDR, a user profile request message including a subscriber Id obtained from the session establishment request message.

4. The method of claim 1 comprising reading, by the PCF and from the first usage monitoring profile, the first limitId and wherein creating the mapping between the monitoring key and the first limitId includes creating a record in a policy database local to the PCF and storing the first limitId and the monitoring key in the record.

5. The method of claim 1 comprising receiving from the SMF, an N7 session terminate request message including the monitoring key, and, in response, terminating the first PDU session.

6. The method of claim 5 wherein re-using the monitoring key for the second PDU session includes:
fetching, by the PCF and from the UDR, a subscriber profile having the second usage monitoring profile and the second limitId; and
creating, by the PCF, a mapping between the monitoring key and the second limitId.

7. The method of claim 6 wherein re-using the monitoring key for the second PDU session includes communicating the monitoring key to the SMF in a usage monitoring grant for the second PDU session.

8. The method claim 6 comprising reading, by the PCF and from the second usage monitoring profile, the second limitId and wherein creating the mapping between the monitoring key and the second limitId includes creating a record in a policy database local to the PCF and storing the second limitId and the monitoring key in the record.

9. The method of claim 1 wherein the monitoring key comprises a usage monitoring Id (umId).

10. The method of claim 1 comprising storing, at the SMF, a single policy and charging control (PCC) rule for the first and second usage monitoring profiles.

11. A system for re-using a monitoring key in quota management by a policy control function (PCF), the system comprising:
a PCF including at least one processor and a memory;
a policy database stored in the memory; and
a policy manager implemented by the at least one processor for receiving, from a session management function (SMF), a first session establishment request message for establishing a first packet data unit (PDU) session involving a subscriber, fetching, from a unified data repository (UDR), a subscriber profile having a first usage monitoring profile including a first limitId, creating, by the PCF, a mapping between a monitoring key and the first limitId, communicating, to the SMF, the monitoring key, and re-using the monitoring key for a second PDU session, the second PDU session having a second usage monitoring profile different from the first usage monitoring profile, the second usage monitoring profile including a second limitId different from the first limitId.

12. The system of claim 11 wherein the policy manager is configured to receive the first session establishment request message from the SMF.

13. The system of claim 11 wherein the policy manager is configured to fetch the subscriber profile from the UDR by transmitting a user profile request message including a subscriber Id obtained from the session establishment request message.

14. The system of claim 11 wherein the policy manager is configured to read, from the first usage monitoring profile, the first limitId and to create the mapping between the monitoring key and the first limitId by creating a record in the policy database and storing the first limitId and the monitoring key in the record.

15. The system of claim 11 wherein the policy manager is configured to receive from the SMF, an N7 session terminate request message including the monitoring key, and, in response, terminate the first PDU session.

16. The system of claim 15 wherein the policy manager is configured to re-use the monitoring key for the second PDU session by:
fetching, from the UDR, a subscriber profile including the second usage monitoring profile including the second limitId; and
creating a mapping between the monitoring key and the second limitId.

17. The system of claim 16 wherein the policy manager is configured to re-use the monitoring key for the second PDU session by communicating the monitoring key to the SMF in a usage monitoring grant for the second PDU session.

18. The system of claim 16 wherein the policy manager is configured to read from the second usage monitoring profile, the second limitId and create the mapping between the monitoring key and the second limitId by creating a record in the policy database and storing the second limitId and the monitoring key in the record.

19. The system of claim 11 wherein the monitoring key comprises a usage monitoring Id (umId).

20. A non-transitory computer readable medium having stored thereon executable instructions that when executed by a processor of a computer control the computer to perform steps comprising:
receiving, by a policy control function (PCF) and from a session management function (SMF), a first session establishment request message for establishing a first packet data unit (PDU) session involving a subscriber;
fetching, by the PCF and from a unified data repository (UDR), a subscriber profile having a first usage monitoring profile including a first limitId;
creating, by the PCF, a mapping between a monitoring key and the first limitId;
communicating, by the PCF and to the SMF, the monitoring key; and
re-using, by the PCF, the monitoring key for a second PDU session, the second PDU session having a second usage monitoring profile different from the first usage monitoring profile, the second usage monitoring profile including a second limitId different from the first limitId.
